(19) United States
(12) Patent Application Publication
(10) Pub. No.: US 2006/0056803 A1
(43) Pub. Date: Mar. 16, 2006

(54) Recording medium, method for searching contents recorded within the recording medium, and method and apparatus for reproducing the recorded contents

(76) Inventors: Kang Soo Seo, Anyang-si (KR); Jea Yong Yoo, Seoul (KR); Byung Jin Kim, Seongnam-si (KR)

Correspondence Address: HARNESS, DICKEY & PIERCE, P.L.C., P.O. BOX 8910, RESTON, VA, 20195, US

(21) Appl. No.: 11/224,242

(22) Filed: Sep. 13, 2005

Related U.S. Application Data
(60) Provisional application No. 60/608,889, filed on Sep. 13, 2004.

(30) Foreign Application Priority Data
Apr. 22, 2005 (KR) 10-2005-0033483

(51) Int. Cl. H04N 5/783

(52) U.S. Cl. 386/69; 386/95

(57) ABSTRACT

A recording medium includes an area having a plurality of contents recorded therein, and a management area having a search file for searching the contents recorded therein. The search file includes at least one entry classifying the contents by scenes and including information having an attribute defined for each scene. In a method for searching contents recorded within the recording medium, character information for each character map (C-Map) recorded within a search file in accordance with a contents search command is first provided. Then, item information for each at least one item map (IS-Map) corresponding to a selected character among the provided character information is provided. Thereafter, an entry corresponding to a selected item among the provided item information is provided. And, finally, the corresponding entry by using entry location information recorded within the selected entry among the provided entries is searched.

This application claims the benefit of U.S. Provisional Application No. 60/608,899, filed on Sep. 13, 2004, in the name of inventors Kang Soo SEO, Jea Yong YOO, and Byung Jin KIM, entitled “METHOD OF ENHANCED SEARCHING THE CONTENTS IN BLU-RAY DISC”, which is hereby incorporated by reference as if fully set forth herein.

This application claims the benefit of the Korean Patent Application No. 10-2005-0033483, filed on Apr. 22, 2005, which is hereby incorporated by reference as if fully set forth herein.

### BACKGROUND OF THE INVENTION

1. Field of the Invention

The present invention relates to a recording medium, and more particularly, to a recording medium, a method for searching contents recorded within the recording medium, and a method and apparatus for reproducing the recorded contents. Although the present invention is suitable for a wide scope of applications, it is particularly suitable for configuring a search file in order to search contents recorded within the recording medium and reproducing the recorded contents.

2. Discussion of the Related Art

Optical discs are widely used as a recording medium for recording mass data. Presently, among a wide range of optical discs, a new high density recording medium, such as a blu-ray disc (hereinafter referred to as “BD”), is under development for recording (or writing) and storing high definition video and audio data for a long period of time. Currently, the blu-ray disc (BD), which is known to be the next generation recording medium technology, is under development as a next generation optical recording solution that is capable of recording data significantly surpassing the conventional DVD, along with many other digital apparatuses. A global standard for the specification of such technology is also under discussion and development.

Most particularly, titles having data of different attributes as their contents may also be recorded in the blu-ray disc (BD). Examples of such data would be titles having motion picture data recorded therein in MPEG-2 format, titles having interactive information including motion picture data recorded therein, the motion picture data being executed (or played-back) by java programs, titles that are recorded in web programming language, and so on. However, in the current BD standard, universal standardization details for searching and reproducing (or playing-back) the contents having different attributes are yet to be consolidated, there are many restrictions in the full-scale development of a blu-ray disc (BD)-based optical recording and/or reproducing apparatus.

### SUMMARY OF THE INVENTION

Accordingly, the present invention is directed to a recording medium, a method for searching contents recorded within the recording medium, and a method and apparatus for reproducing the recorded contents that substantially obviate one or more problems due to limitations and disadvantages of the related art.

An object of the present invention is to provide a method for configuring a search file in order to search contents recorded in the recording medium, such as a blu-ray disc.

Another object of the present invention is to provide a method for searching contents from the recording medium, which includes the search files, and a method and apparatus for reproducing the recording medium by using the file structure within the recording medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a recording medium includes an area having a plurality of contents recorded therein, and a management area having a search file for searching the contents recorded therein, wherein the search file includes at least one entry classifying the contents by scenes and including information having an attribute defined for each scene.

The search file may further include map information that is classified by the attribute of the entry. The map information recorded in the search file may consist of a plurality of item maps (IS-Maps) designating an entry having the same item attribute among the at least one entry, and a plurality of character maps (C-Maps) designating an item map (IS-Map) having the same character among the plurality of item maps (IS-Maps).

In another aspect of the present invention, a method for searching contents recorded within a recording medium includes providing character information for each character map (C-Map) recorded within a search file in accordance with a contents search command, providing item information for each at least one item map (IS-Map) corresponding to a selected character among the provided character information, providing an entry corresponding to a selected item among the provided item information, and searching the corresponding entry by using entry location information recorded within the selected entry among the provided entries.

In another aspect of the present invention, in reproducing a recording medium including at least one title recording area, and a management area having a management file for reproducing a title and a search file each recorded therein, a method for reproducing the recording medium includes reading an index file and an object file both recorded in the management area within the recording medium, when a reproduction command for a specific title is inputted by the index file, executing a specific object file associated with the corresponding specific title, when a search command for a set of contents within the title is inputted while the title is being reproduced by using the object file, pausing the reproduction of the title and searching the specific set of contents within the title from a search information included in the search file, and after ending the search operation, resuming the reproduction of the title starting from a presentation point at which the reproduction has been paused.

In another aspect of the present invention, in reproducing a recording medium including at least one title recording area, and a management area having a management file for reproducing a title and a search file each recorded therein, a method for reproducing the recording medium includes reading an index file and an object file both recorded in the management area within the recording medium, when a reproduction command for a specific title is inputted by the index file, executing a specific object file associated with the corresponding specific title, when a search command for a set of contents within the title is inputted while the title is being reproduced by using the object file, stopping the reproduction of the title and searching the specific set of contents within the title from a search information included in the search file, and in accordance with a result of the search operation, resuming the reproduction of the title starting from a searched scene which is finally selected by a user.

In another aspect of the present invention, in reproducing a recording medium including at least one title recording area, and a management area having a management file for reproducing a title and a search file each recorded therein, an apparatus for reproducing the recording medium includes a recording/reproducing unit reading an index file and an object file both recorded in the management area within the recording medium, and a player model executing a specific object file associated with the corresponding specific title, when a reproduction command for a specific title is inputted by the index file, pausing the reproduction of the title and searching the specific set of contents within the title from a search information included in the search file, when a search command for a set of contents within the title is inputted while the title is being reproduced by using the object file, and resuming the reproduction of the title starting from a presentation point at which the reproduction has been paused after ending the search operation.

In a further aspect of the present invention, in reproducing a recording medium including at least one title recording area, and a management area having a management file for reproducing a title and a search file each recorded therein, an apparatus for reproducing the recording medium includes a recording/reproducing unit reading an index file and an object file both recorded in the management area within the recording medium, and a player model executing a specific object file associated with the corresponding specific title, when a reproduction command for a specific title is inputted by the index file, stopping the reproduction of the title and searching the specific set of contents within the title from a search information included in the search file, when a search command for a set of contents within the title is inputted while the title is being reproduced by using the object file, and resuming the reproduction of the title starting from a searched scene which is finally selected by a user in accordance with a result of the search operation.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates each title recorded on a recording medium (e.g., BD-ROM) according to the present invention;

FIGS. 2A to 2D illustrate examples of a file structure recorded on the recording medium (i.e., optical disc) and its relationship for reproducing data according to the present invention;

FIG. 3 illustrates a recording structure of data recorded on the recording medium (i.e., optical disc) according to the present invention;

FIG. 4 illustrates a file structure recorded on the optical disc according to an embodiment of the present invention and its relationship for reproducing data by using the file structure;

FIG. 5 illustrates a configuration of search information for searching contents for each title according to the embodiment of the present invention;

FIG. 6 illustrates a detailed configuration of the search information of FIG. 5;

FIGS. 7A and 7B illustrate a general view of a method for configuring the search file according to the embodiment of the present invention;

FIG. 8 illustrates a method for configuring the searching information for each language into a separate search file according to an embodiment of the present invention;

FIGS. 9A and 9B illustrate a method for configuring search information created in all languages into a single search file according to the embodiment of the present invention;

FIG. 10 illustrates a method for managing the search information according to the embodiment of the present invention;

FIG. 11A illustrates an overall optical recording and/or reproducing apparatus according to the present invention; and

FIG. 11B illustrates a player model according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meaning of each term lying within.

In this detailed description, “recording medium” refers to all types of medium in which data can be recorded and broadly includes all types of medium regardless of the recording method, such as an optical disc, a magnetic tape, and so on. Hereinafter, for simplicity of the description of the present invention, the optical disc and, more specifically, the “Blu-ray disc (BD)” will be given as an example of the recording medium proposed herein. However, it will be apparent that the spirit or scope of the present invention may be equally applied to other types of recording medium.

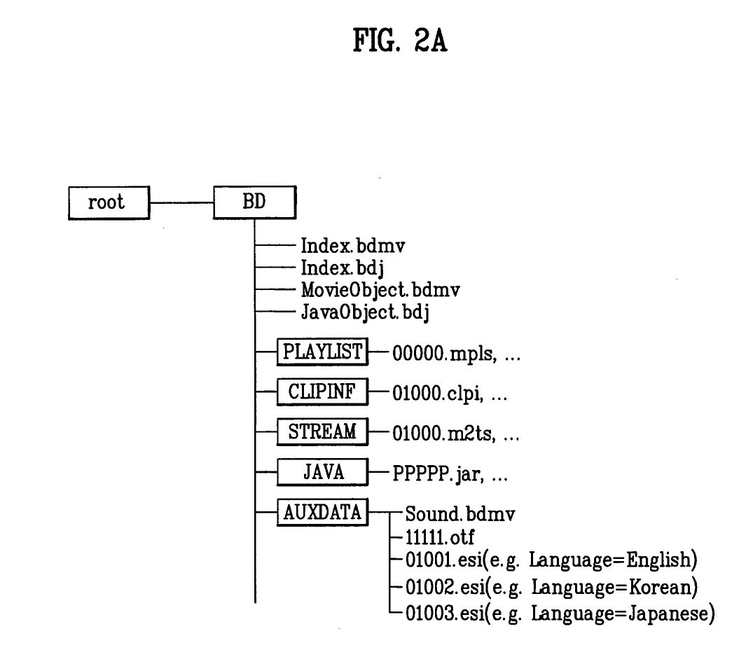

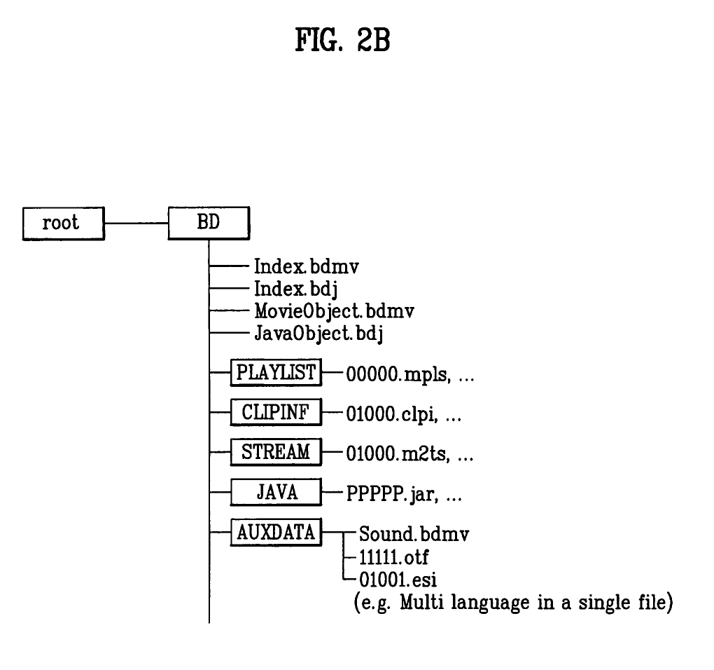

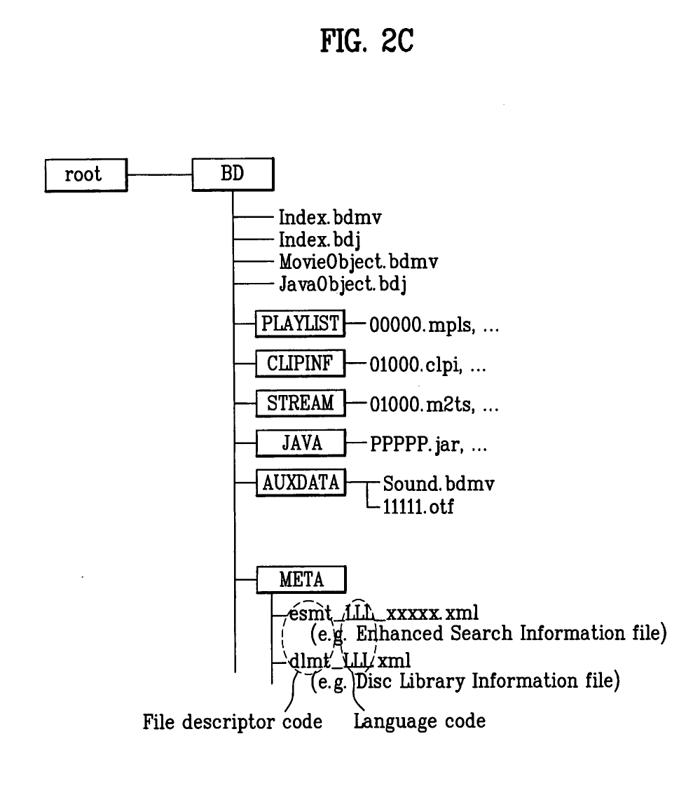

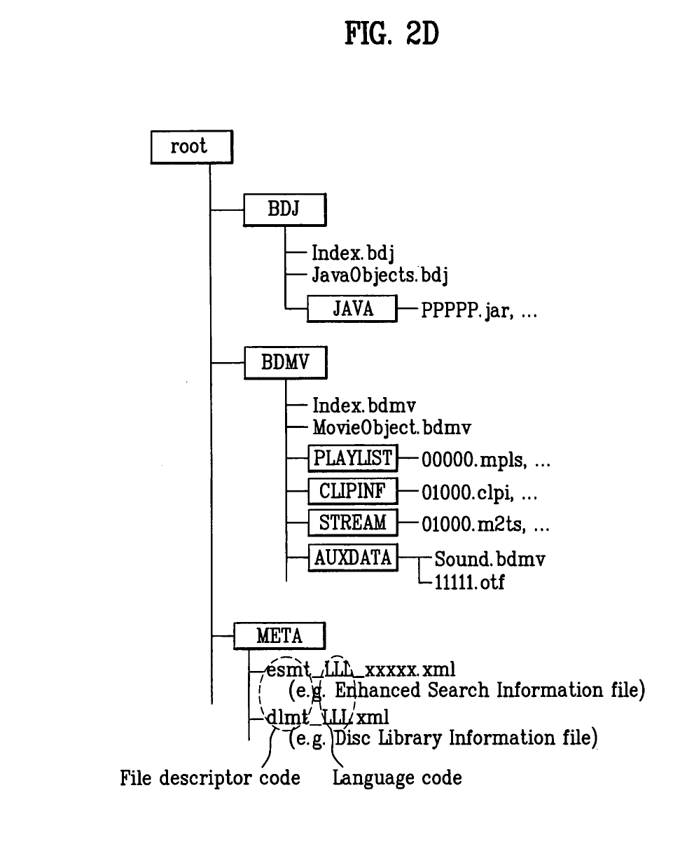

In the present invention, a “title” refers to a reproduction (or playback) unit forming an interface with the user. More specifically, each title according to the present invention is linked with a specific object. And, a stream associated with the corresponding title recorded on the optical disc is reproduced in accordance with a command or program within the object. Accordingly, a relationship between the title recorded on the optical disc and a file structure within the optical disc for reproducing the title will be described in detail with reference to FIGS. 2A to 2D. More specifically, in order to simplify the description of the present invention, among the titles recorded on the optical disc, a title having MPEG-2 compression type motion picture data and interactive information recorded therein will be referred to as a “High Definition Movie (HDMV) title”. A title having motion picture data and interactive information, which are executed by a Java program, are recorded therein is referred to as a “Java title”. A set of motion picture contents configuring the title consists of a picture, which is referred to as a scene. In a method of authoring the optical disc according to the present invention, a position information for efficiently searching a specific scene within the title is configured as a search file.

Furthermore, in the present invention, an “object” refers to a reproduction management information including a command or program for reproducing the optical disc. More specifically, various types of objects exist within the disc, wherein each object is either linked with a specific title or inter-linked with other objects within the disc. Therefore, the objects are designed in advance as required or in accordance with the intentions of the author, thereby enabling a wide range of disc reproduction scenarios to be provided. In other words, the object according to the present invention may be viewed as a reproduction unit including a command or program for managing a reproduction scenario of the data recorded on the optical disc. Accordingly, the object for reproducing the “HDMV title” is referred to as a “Movie Object” or “M-OBJ”, and the object for reproducing the “Java title” is referred to as a “Java Object” or “J-OBJ”.

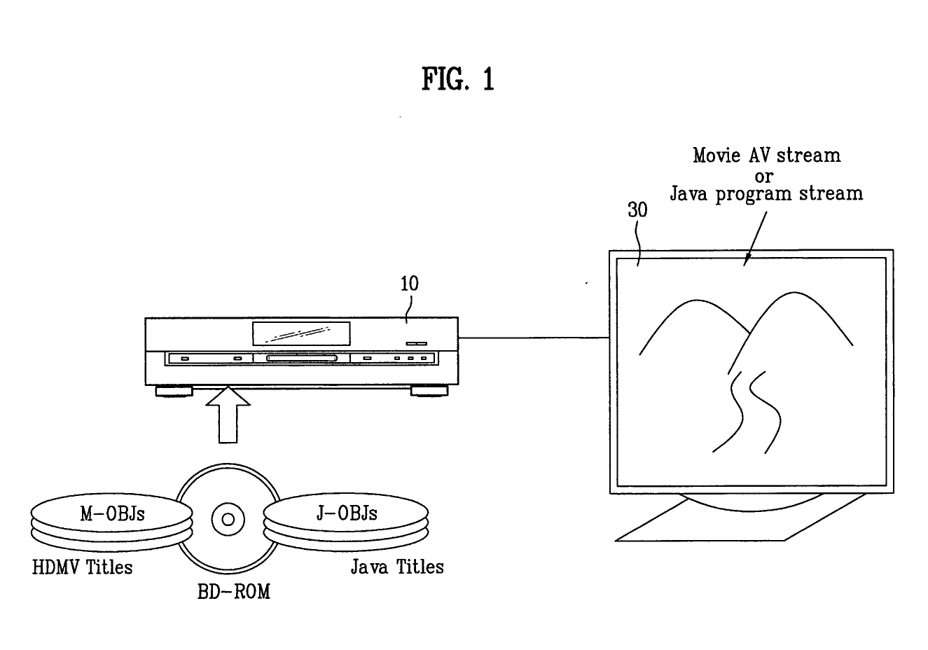

FIG. 1 provides a conceptual understanding of the present invention. More specifically, FIG. 1 illustrates an example of reproducing a read-only blu-ray disc (BD-ROM) through an optical recording and/or reproducing device 10. Particularly, FIG. 1 illustrates an example of when the titles recorded on the BD-ROM consist of a combination of HDMV titles and Java titles (which is referred to as a “Full mode”). The present invention is to provide a standardized file structure within the optical disc, so that the contents within the optical disc having only the HDMV titles recorded therein or the BD-ROM being recorded in “Full mode” can be searched. The present invention also seeks to provide a method for searching the recorded contents and a method and apparatus for reproducing the recorded contents.

Accordingly, the optical recording and/or reproducing device 10 of the present invention can record or reproduce data on or from optical discs of various standards. And, depending upon its design, the optical recording and/or reproducing device 10 may either record/reproduce optical discs of only one particular standard (e.g., the blu-ray disc (BD)) or only reproduce data and not perform any recording of data. In the present invention, an example of a player (i.e., BD-Player) for reproducing the read-only blu-ray disc (i.e., BD-ROM). Herein, a plurality of titles is recorded on the BD-ROM in accordance with the format of the BD-ROM. It is apparent that the optical recording and/or reproducing apparatus 10 can also be referred to as a “driver” which may be equipped in computers.

Apart from the function of reproducing the blu-ray disc (BD-ROM), the optical recording and/or reproducing apparatus 10 according to the present invention also has the function of reading the data within the BD-ROM, performing signal processing and decoding in accordance with the read data, and transmitting the decoded signal to a display 30, which is connected to the optical recording and/or reproducing apparatus 10, so as to transmit the signal to a user through a display screen. Accordingly, the optical recording and/or reproducing apparatus 10 is primarily designed to reproduce all titles that are recorded within the BD-ROM, each of the titles having attributes different from one another. However, as described above, the optical recording and/or reproducing apparatus 10 may reproduce titles of specific attributes only (e.g., HDMV titles).

FIGS. 2A to 2D illustrate various examples of a file structure recorded on the recording medium (e.g., BD-ROM). The file structure of FIG. 2A will now be described in detail. In the reproduction management file structure, at least one BD directory (BD directory) is included in a root directory. Each BD directory includes index files (“index.bdmv” and “index.bdj”) and object files (“MovieObject.bdmv” and “JavaObject.bdj”) as general file information, which ensure interactivity with one or more users. Each BD directory includes three file directories including data to be reproduced, and information required for reproducing the data. The file directories included in each BD directory are a playlist directory (PLAYLIST), a clip information directory (CLIPINF), a stream directory (STREAM), a Java directory (JAVA), which consists of one or more Java program files, and an auxiliary data directory (AUXDATA), which consists of auxiliary data associated with the reproduction of the optical disc. Hereinafter, the above-mentioned directories and the files included in each directory will be described in detail.

The stream directory includes a plurality of AV stream files recorded in specific formats within the optical disc. For example, “*.m2ts” is used for naming the stream files (e.g., 01000.m2ts). Additionally, the clip information directory (CLIPINF) includes clip information files (e.g., 01000.clpi, . . . ) being in one-to-one correspondence with each of the stream files included in the stream directory. A clip information file (*.clpi) includes property information and timing information of a corresponding stream file. More specifically, in the BD standard, a stream file (*.m2ts) and a clip information file (*.clpi) that is in one-to-one correspondence with the stream file are collectively referred to as a “clip”. In other words, a clip information file (*.clpi) corresponding to each stream file (*.m2ts) must exist.

The playlist directory (PLAYLIST) includes a plurality of PlayList files (*.mpls), wherein each PlayList file (e.g., 00000.mpls) includes at least one PlayItem which designates playing interval for a specific clip. In other words, a PlayItem includes information designating presentation start and end times (IN-Time and OUT-Time) of a specific clip. Herein, the specific clip is designated by a clip_Information_File_name within the PlayItem. The PlayList file (*.mpls) reproduces a desired clip from a combination of one or more PlayItems. Further, the PlayList file (*.mpls) also includes a SubPlayItem for reproducing data (most particularly, sub data) that is different from the data reproduced by the PlayItem.

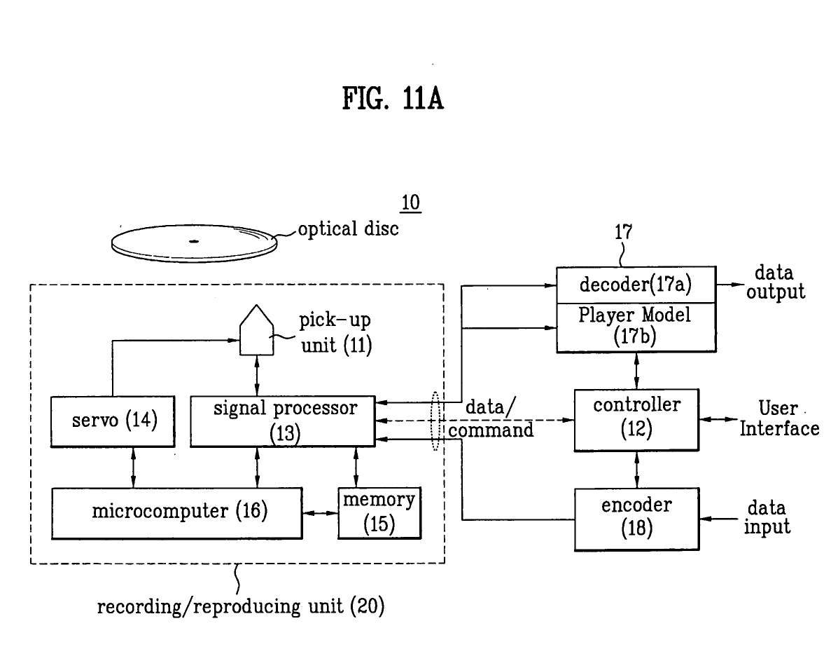

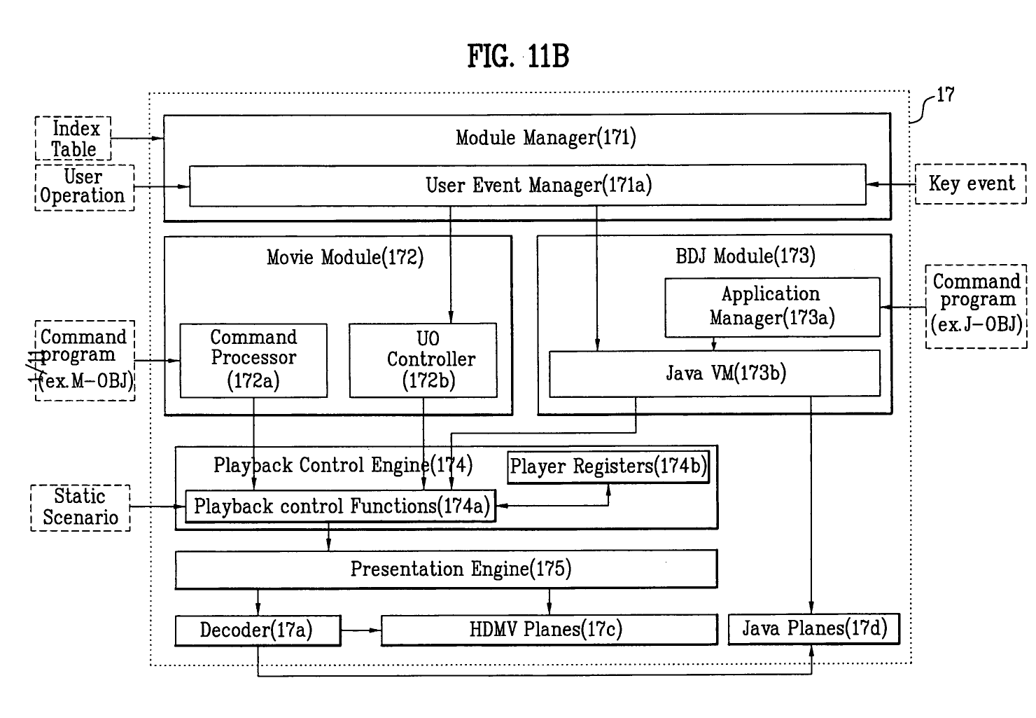

More specifically, the PlayList file is operated (or executed) only by the command made by the specific object within the object file (“Movieobject.bdmv” and “JavaObject.bdmv”). Accordingly, from the perspective of a disc reproduction scenario, the Object executes or manages a dynamic scenario, and the PlayList file (*.mpls) executes or manages a static scenario. Furthermore, the Java directory (JAVA) includes Java program files (e.g., PPPPP.jar, . . . ). Various types of applications are programmed in each Java program file, which is particularly referred to as an “Xlet”. The Java program file is processed by a Java-specific reproduction means, which will be described in detail in a later process with reference to FIG. 11B.

The auxiliary data directory (AUXDATA) consists of files including auxiliary information associated with the reproduction of the optical disc. For example, the AUXDATA may include a sound file (“Sound.bdmv”), a font file (e.g., “11111.otf”). The sound file provides information when reproducing the optical disc, such as a click sound and menu sound information. The font file provides font information when reproducing the text subtitle. According to the present invention, the AUXDATA may also include a search file (“*.esi”) for searching a specific set of contents within the optical disc.

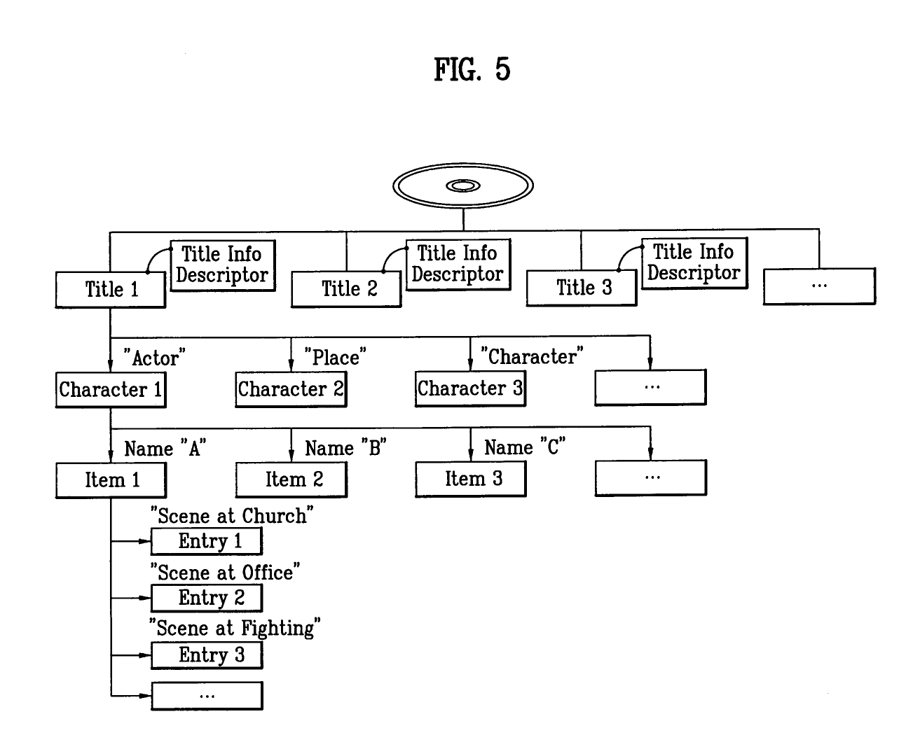

Referring to FIG. 2A, in configuring the search file according to the present invention, a separate search file may be configured for each language. For example, the search file configured in English may be named “01001.esi”, the search file configured in Korean may be named “01002.esi”, and the search file configured in Japanese may be named “01003.esi”. The configuration of the search file will be described in more detail in a later process with reference to FIG. 5.

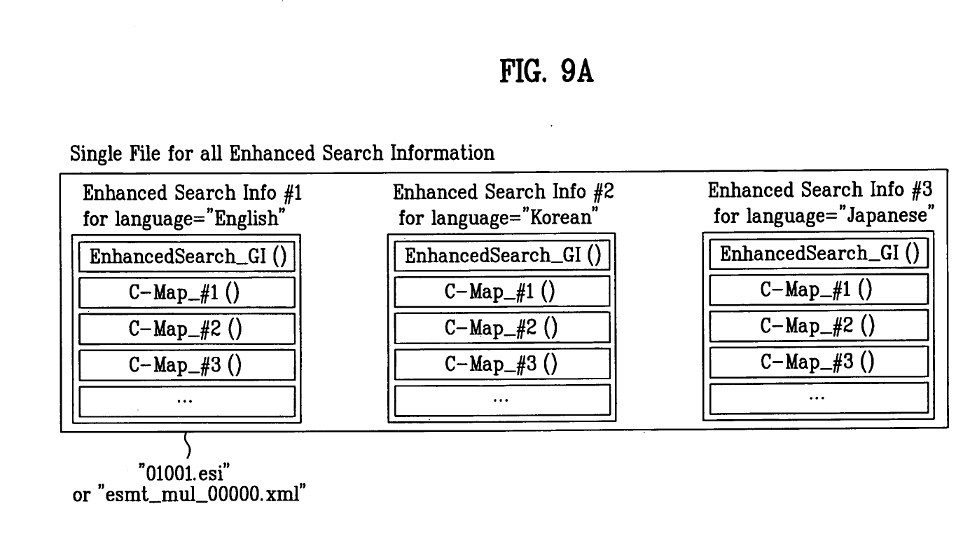

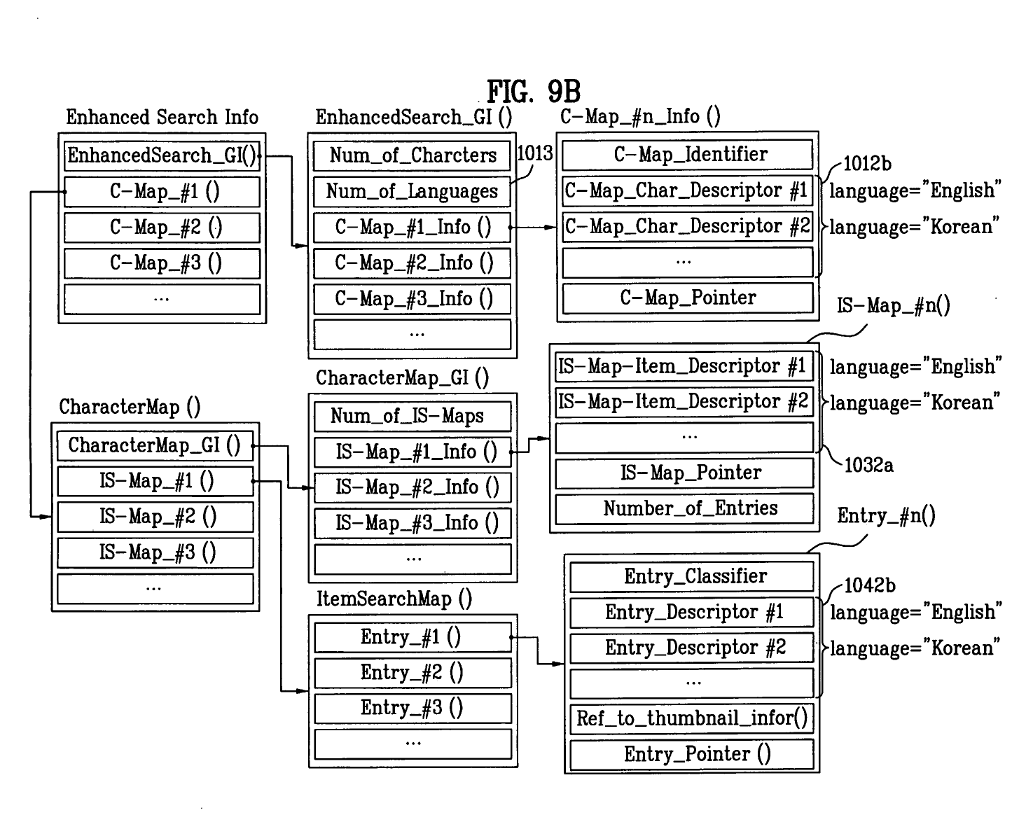

FIG. 2B illustrates another example of the file structure according to the present invention. Referring to FIG. 2B, and in comparison with the structure of FIG. 2A, in configuring the search file according to the present invention, all of the languages that are supported may be configured in a single search file. For example, English, Korean, and Japanese may all be supported in the same search file “01001.esi”. The configuration of all languages being supported in a single search file will be described in more detail with reference to FIG. 9A and FIG. 9B.

FIG. 2C illustrates yet another example of the file structure according to the present invention. Referring to FIG. 2C, and in comparison with the structures of FIGS. 2A and 2B, in configuring the search file according to the present invention, the search file is included in a separate meta data directory (META) instead of the auxiliary data directory (AUXDATA). Herein, the search file uses a specific file name different from the other meta data files. More specifically, the BD directory includes the meta data directory (META). However, the search file according to the present invention is recorded to have a file name such as “esmt_LLL_xxxxx.xml”. In other words, the beginning of the file name “esmt_” is used as a file descriptor code that differentiates the search file from the other meta data files. Therefore, all files beginning with “esmt_” represent search files (and most particularly, “enhanced search meta data”). On the other hand, all files beginning with “dlmt_” represent disc library files.

In addition, “_LLL_” which also configures the search file is used as a language code that can differentiate and identify the language information supported by the search file. More specifically, the search file configured in English may be indicated as “_eng_”. Similarly, the search file configured in Korean may be indicated as “_kor_”, and the search file configured in Japanese may be indicated as “_jpn_”. And, the search file configured in a plurality of languages may be indicated as “_mul_”. Furthermore, the end of the file name “_xxxxx” is used as an identification code for differentiating the PlayList file (e.g., 00000.mpls, . . . ) corresponding to the search information included that configures the search file. For example, when a specific title within the optical disc is reproduced by a specific PlayList file “00000.mpls”, the file name of the search file configured in English used to search the contents information within the corresponding title is indicated as “esmt_eng_{—}0000.xml”.

FIG. 2D illustrates yet another example of the file structure according to the present invention. In this example, a directory for managing reproduction performed by a Java program (i.e., BDJ), a directory for managing reproduction of HDMV titles (i.e., BDMV), and a meta data directory (META) are included under a single root directory. More specifically, the directory (BDJ) for managing reproduction performed by a Java program includes an index file (index.bdj) and an object file (JavaObject.bdj) and also includes a directory (JAR) including a Java program file (PPPPP.jar, . . . ). The directory (HDMV) for managing reproduction of the HDMV titles an index file (index.bdmv) and an object file (MovieObject.bdmv), and also includes the above-described PlayList directory (PLAYLIST), clip information directory (CLIPINF), stream directory (STREAM), and auxiliary data directory (AUXDATA). The meta data directory (META) includes the search file having the file name of “esmt_LLL_xxxxx.xml”, shown in FIG. 2C. In the file structure shown in FIG. 2D, even if the reproduction performed by a Java program cannot be supported in a specific optical recording and/or reproducing apparatus 10, only the HDMV titles can be reproduced through the BDMV directory. Conversely, when the reproduction performed by a Java program is supported in a specific optical recording and/or reproducing apparatus 10, both the Java titles and the HDMV titles can be reproduced through the BDJ directory.

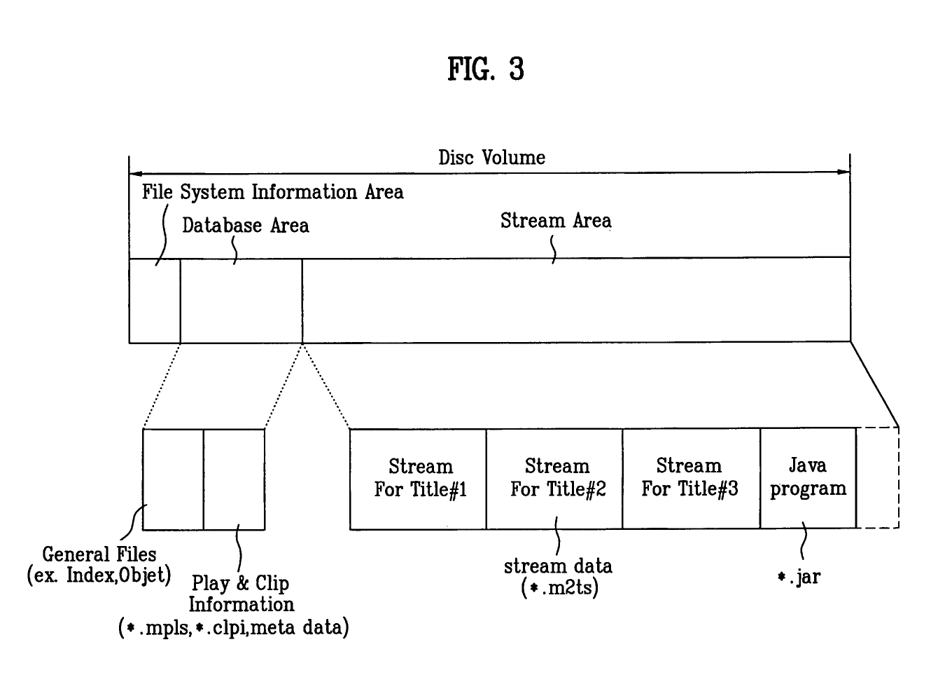

FIG. 3 illustrates an exemplary structure of the information associated with the above-described file structure (shown in FIGS. 2A to 2D) being recorded within the optical disc. More specifically, starting from the inner circumference (or center) of the disc, the disc volume includes a file system information area occupying the inmost portion of the disc volume, an AV stream area occupying the outmost portion of the disc volume, and a database area occupied between the file system information area and the stream area. In the file system information area, system information for controlling the entire data files is recorded. And, main data such as audio/video/graphic data are recorded in the stream area. Files that are used for reproducing the recorded stream data (*.m2ts), such as index files, object files, PlayList files, clip information files, and meta data files, are recorded in the database area of the disc volume.

As described above, motion picture contents may be recorded as the data recorded in the stream area within the optical disc according to the present invention. And, information for searching the motion picture contents are recorded within the search file as the meta data files. Furthermore, an area for recording file information for reproducing the motion picture contents recorded in the stream area is referred to as a “management area”. This area corresponds to the File system information area and the database area shown in FIG. 3. Herein, each area shown in FIG. 3 is only exemplary, and, therefore, the alignment of each of the areas is not limited to the structure shown in FIG. 3.

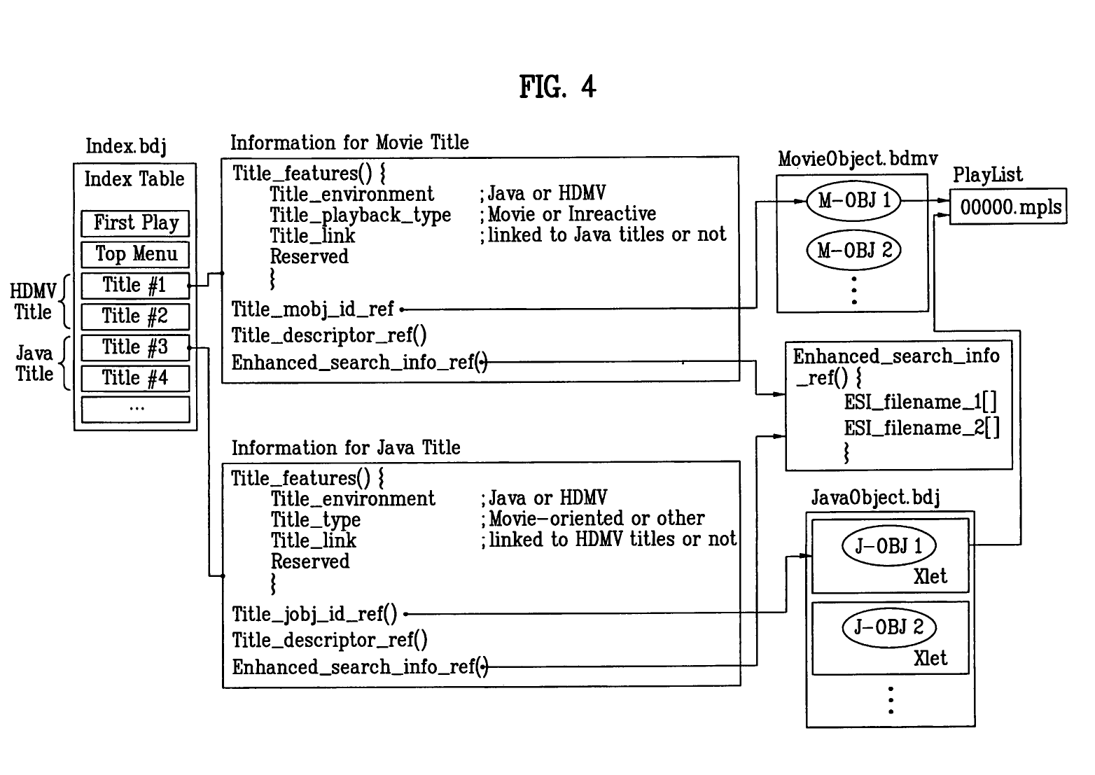

FIG. 4 illustrates a file structure recorded on the optical disc according to an embodiment of the present invention and its relationship for reproducing data by using the file structure. In other words, FIG. 4 illustrates the relationship of a specific title being reproduced by the file structure shown in FIGS. 2A to 2D. Most particularly, the drawing describes in detail the relationship of the corresponding title being reproduced, when a title reproduction command is made by a user for the specific title that is provided to an index table configured based on an index file.

An example of an optical recording and/or reproducing apparatus 10 that can support the Java programs will be given with reference to FIG. 4. And, in this case, the index file uses the Java index file (index.bdj). The index file (index.bdj) includes “First Play” information, “TopMenu” information, and at least one “Title” (i.e., Title #1 to Title #4) information. Herein, the title (i.e., Title #1 to Title #4) may be configured of any one of an HDMV title and a Java title. Accordingly, each title (Title #1 to Title #4) includes information indicating the attribute of each title. Herein, each title includes a “Title_feature( )” field, a “Title_mobj_id_ref( )” field (or a “Title_jobj_id_ref( )”), a “Title_descriptor_ref( )” field, and an “Enhanced_search_info _ref( )” field. The “Title_feature( )” field indicates the features of the title, and the “Title_mobj_id_ref( )” field (or a “Title_jobj_id_ref( )”) designates a specific object having a reproduction scenario information of the corresponding title. The “Title_descriptor_ref( )” field indicates the attribute of the corresponding title, and the “Enhanced_search_info_refo” field designates a search file including the search information within the corresponding title.

More specifically, the “Title_feature( )” field includes “Title_environment” information, “Title_playback_type” information, and “Title_link” information. The “Title _environment” information indicates whether the reproduction (or playback) environment of the corresponding title is performed by a Java program or a motion picture HDMV. The “Title_playback_type” information indicates whether the attribute of the reproduced title is a motion picture movie title or a title for interactive usage with the user. The “Title_link” information indicates whether the corresponding title is linked with another title of a different attribute. For example, if the corresponding title is an HDMV title, the “Title_link” information indicates whether the title is linked with a Java title. Conversely, if the corresponding title is a Java title, the “Title_link” information indicates whether the title is linked with an HDMV title.

Among the search files included in the file structure described above with reference to FIGS. 2A to 2D, a search file name including the search information associated with the corresponding title is recorded in the “Enhanced _search_info_ref( )” field. For example, the search file name is recorded in one of “ESI_filename_{—}1( )” and “ESI_filename_{—}2( )”. Accordingly, when the user selects a specific title including the above-described title information, the corresponding is reproduced (or played-back) in a later process. The relationship of the title being reproduced will now be described in detail.

When the user selects the reproduction of a specific HDMV title (e.g., Title #1), a specific PlayList (e.g., 00000.mpls) is reproduced in accordance with a command or program defined by a specific object (e.g., M-OBJ 1) within a Movie Object file (MovieObject.bdmv), which is designated by the “Title_mobj_id_refo” field included in the title information. And, a specific clip (which consists of “*.clpi” and “*.m2ts”) is reproduced by a PlayItem within the PlayList. Alternatively, when the user selects the reproduction of a specific Java title (e.g., Title #3), a specific PlayList (e.g., 00000.mpls) is reproduced in accordance with a command or program defined by a specific object (e.g., J-OBJ 1) within a Java Object file (JavaObject.bdj), which is designated by the “Title_jobj_id _ref( )” field included in the title information. And, a specific clip (which consists of “*.clpi” and “*.m2ts”) is reproduced by a PlayItem within the PlayList. Each object (e.g., J-OBJ 1, J-OBJ 2, . . . ) within the Java Object file (JavaObject.bdj) includes an application ID (application_id), which executes an application existing within a specific Java program file (*.jar). With the execution of the application designated by the application_id, the title can be reproduced by the corresponding Java program.

FIG. 5 illustrates a configuration of search information for searching contents for each title according to the embodiment of the present invention. Referring to FIG. 5, when a plurality of titles (i.e., Title 1, Title 2, Title 3, . . . ) exists within the optical disc, the contents within each title are divided into scenes, so as to configure a scene entry having the attribute for each scene defined therein. Accordingly, in configuring the search information, the corresponding scene entry is divided once again by the attributes of the entry. Herein, entries having the same attribute are described as a specific “item” information. And, among the plurality of described items, the item having the same character is described as a “Character”. For example, Title 1 is divided into a plurality of characters (Character 1, Character 2, Character 3, . . . ) having the same character. Then, each character is divided into a plurality of items (Item 1, Item 2, Item 3, . . . ) each having the same attribute. And, each item includes at least one scene entry having the same attribute.

Therefore, when the user wishes to search a specific set of contents within Title 1, the plurality of characters (Character 1, Character 2, Character 3, . . . ) is first displayed on a main screen. For example, Character 1 may consist of a group of actors, Character 2 may consist of a group of place, and Character 3 may consist of a group of featuring characters. Subsequently, when the user wishes to search a specific actor, Character 1 is first selected, and then the plurality of items (Item 1, Item 2, Item 3, . . . ), which is classified by the names of specific actors, is displayed. Thereafter, when the user selects the name of a specific actor (e.g., Name A) at least one entry (Entry 1, Entry 2, Entry 3, . . . ) in which the corresponding actor features is provided. Finally, when the user selected a specific entry, a specific scene corresponding to the selected entry is provided. Therefore, according to the present invention, the scene entry of a specific scene within a title is used to configure the search information. However, Items and Characters are configured as search information of a higher hierarchy, which classify the scene entry by each attribute.

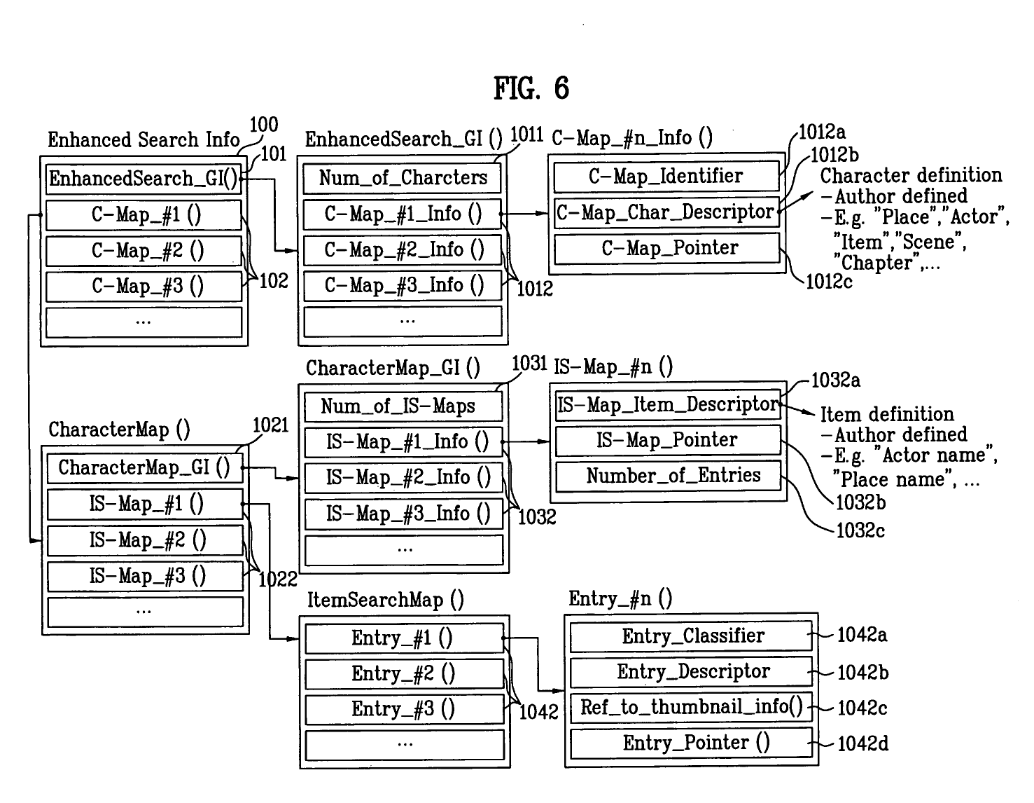

FIG. 6 illustrates a detailed configuration of the search information of FIG. 5. Referring to FIG. 6, the “Item” and “Character” being the search information are configured as map information, thereby being referred to as an ItemSearch-Map (hereinafter referred to as “IS-Map”) 1022 and a Character-Map (hereinafter referred to as “C-Map”) 102, respectively. Herein, a search file 100 includes a general information field (“EnhancedSearch_GIo”) 101 and a plurality of Character-Map fields (“C-Map_#n ( )”). The “EnhancedSearch_-GI( )” field 101 includes information on the number of character maps (“Num_of_Characters”) 1011, and information on each Character-Map (“C-Map_#n_info( )”) 1012. The “C-Map_#n _info( )” 1012 includes a C-Map_identifier 1012a, a C-Map_Char _Descriptor 1012b, and a C-Map Pointer 1012c. The C-Map_identifier 1012a is an identification information indicating the Character-Map. The C-Map_Char_Descriptor 1012b indicates the characters of the corresponding Character-Map. The C-Map_Pointer 1012c is a pointer information indicating the position of the corresponding Character-Map within the search file. The C-Map_Char _Descriptor 1012b is configured of the characters pre-defined by the author of the optical disc. For example, the C-Map_{—}Char_Descriptor 1012b may be defined by characters of “Place”, “Actor”, “Character”, and so on.

In addition, each of the Character-Map field (“C-Map_#n( )” field) 102 within the search file 100 includes a general information field of the corresponding Character-Map (“CharacterMap_GI( )”) 1021, and a plurality of Item-Map fields (“IS-Map_#n( )”) 1022. The “CharacterMap_GI( )” 1021 includes information on the number of Item-Maps (“Num_of_IS-Maps”) 1031 included in the corresponding C-Map 102, and information on each Item-Map (“IS-Map_#n_info( )”) 1032. More specifically, the “IS-Map_#n_info( )” 1032 includes an IS-Map_Item_Descriptor 1032a, an IS-Map_Pointer 1032b, and a Num_of_Entries 1032c. Herein, the IS-Map_Item_Descriptor 1032a is information indicating the characterisitics of a corresponding Item-Map. The IS-Map_Pointer 1032b is a pointer information indicating the position of the corresponding Item-Map within the search file. And, the Num_of_Entries 1032c indicates information on the number of entries included in the corresponding Item-Map 1022. The IS-Map_Item_Descriptor 1032a is configured of the characters pre-defined by the author of the optical disc. For example, when the C-Map, which is of a higher hierarchy, is defined as the “Actor” category, each of the Item-Maps may be defined as the names of individual actors, such as “Name A”, “Name B”, “Name C”, and so on.

Each Item-Map (“IS-Map_#n( )”) 1022 includes information on at least one entry 1042 (i.e., Entry_{—}#1( ), Entry_{—}#2( ), Entry_{—}#3( ), . . . ). Each entry (“Entry_#n( )”) 1042 includes an “Entry_Classifier” 1042a, an “Entry_Descriptor” 1042b, a “Ref_to_thumbnail_info( )” 1042c, and an “Entry_Pointer” 1042d. The Entry_Classifier 1042a includes classification information of a corresponding entry. The Entry_Descriptor 1042b indicates the characters of the corresponding entry. The Ref_to_thumbnail_info( ) 1042c indicates access information associated with a search of the corresponding entry. And, the Entry_Pointer 1042d is a pointer information indicating the position of the corresponding entry within the optical disc.

Hereinafter, examples will be given to describe the diverse information included in the entry (“Entry_#n( )”) 1042. The Entry_Classifier 1042a may be used as information for indicating viewing ratings of a scene represented by a corresponding entry. For example, the Entry_Classifier 1042a may indicate whether the entry is suitable for adult viewers only or whether the entry is suitable for viewers under 18 (or juvenile and adolescent viewers). The Entry_Descriptor 1042b, which indicates the characters of a corresponding entry, indicated the scene represented by the corresponding entry. For example, the Entry_Descriptor 1042b indicates the characters (i.e., “Place”, “Actor”, “Character”, etc.), which are defined in the above-described Character map (C-Map) and Item map (IS-Map). In other words, the information indicated in the Entry_Descriptor 1042b decides in which Item-Map (IS-Map) and Character-Map (C-Map) the corresponding entry is to be included. It is also apparent that the same entry may be included in a plurality of Item-Maps (IS-Maps) and a plurality of Character-Maps (C-Maps).

The Ref_to_thumbnail_info( ) 1042c, which indicates access information associated with a search of the corresponding entry, represents information designating an index or an icon recorded as a separate file, such as a thumbnail information. Herein, the Ref_to_thumbnail_info( ) 1042c may be used as an information for briefly indicating the corresponding entry. And, as described above, the Entry_Pointer 1042d indicates the actual recorded position of the corresponding entry within the optical disc. For example, the Entry_Pointer 1042d may indicate a specific position within the corresponding title as a timing information. Alternatively, the Entry_Pointer 1042d may also indicate the specific position as a mark information within the PlayList that is being reproduced (or played-back).

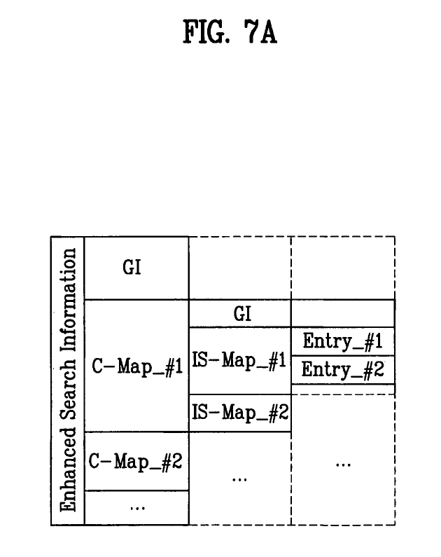

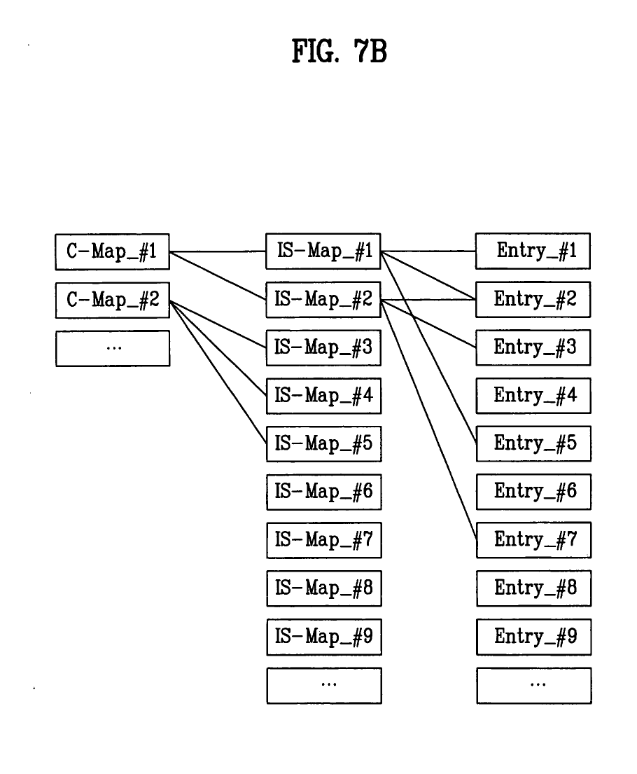

FIGS. 7A and 7B illustrate a general view of a method for configuring the search file according to the embodiment of the present invention. Referring to FIG. 7A, the search information is configured in a hierarchical table structure, such as IS-Maps within a C-Map, and entries within an IS-Map. Referring to FIG. 7B, the search information is configured of a plurality of C-Maps, a plurality of IS-Maps, and a plurality of entries. The search information of FIG. 7B also includes descriptors that designate mapping relationship between the C-Maps, the IS-Maps, and the entries. More specifically, referring to the table structure shown in FIG. 7A, in configuring the search file, a plurality of lower groups (e.g., the IS-Maps) is included in a higher group (e.g., the C-Map). And, at least one entry classified by the same characters is included under each IS-Map. Therefore, even though an entry represents the same scene, if the entry is included in different IS-Maps, the entry is registered within each corresponding IS-Map. Similarly, each IS-Map is included in at least one C-Map. Alternatively, in configuring the search file, the descriptor structure shown in FIG. 7B includes a plurality of C-Maps, a plurality of IS-Maps, and a plurality of entries. However, each Item-Map (IS-Map) includes a mapping information designating at least on C-Map, which is of a higher hierarchical group. And, each entry includes a mapping information designating at least on IS-Map, which is of a higher hierarchical group.

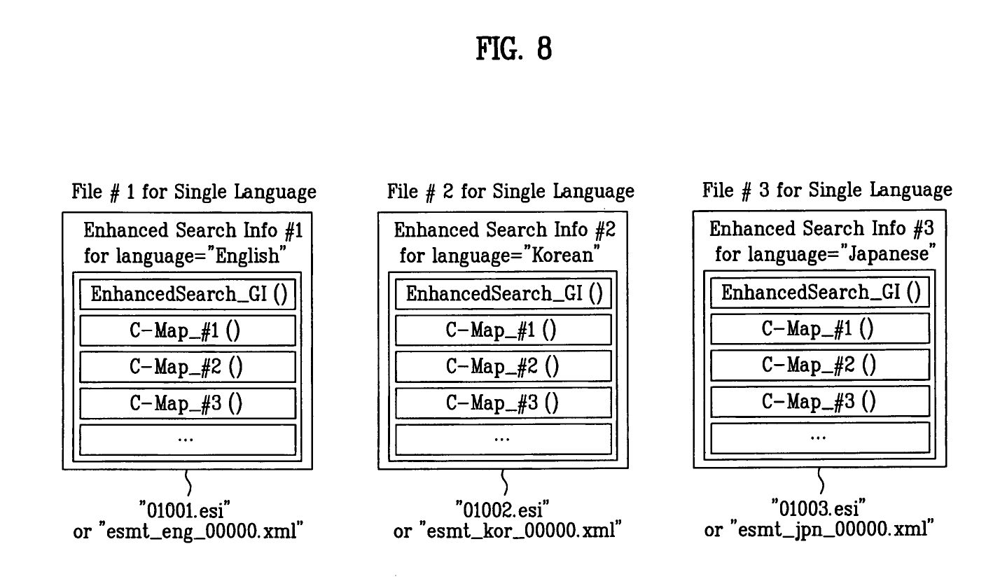

FIG. 8 illustrates a method for configuring the searching information for each language into a separate search file according to an embodiment of the present invention. More specifically, as described in FIG. 2B and FIG. 2C, a search file is separately created (or configured) for each language. For example, the search file configured in English is indicated by using a file name of either “01001.esi” or “esmt_eng_{—}00000.xml”. Also, the search file configured in Korean is indicated by using a file name of either “01002.esi” or “esmt_kor_{—}00000.xml”. Further, search file configured in Japanese is indicated by using a file name of either “01003.esi” or “esmt_Jap_{—}00000.xml”. Accordingly, the structure of the search information included in each search file can be configured identically as the structure shown in FIGS. 7A and 7B.

FIGS. 9A and 9B illustrate a method for configuring search information created in all languages into a single search file according to the embodiment of the present invention. More specifically, as described in FIG. 2B and FIG. 2C, the search file is created (or configured) in a single file integrating all languages that are supported in the optical disc. For example, the search file is indicated by using a file name of either “01001.esi” or “esmt_mul_{—}00000.xml”. FIG. 9A illustrates the structure of the search information included in a search file. Herein, a plurality of search information are created (or configured) for each language, as shown in FIGS. 7A and 7B. On the other hand, in FIG. 9B, the structure of the search information included in a search file is created (or configured) identically as the structure shown in FIGS. 7A and 7B. However, the information of the supported languages are created (or configured) as separate descriptors.

More specifically, referring to FIG. 9B, only the parts of the search information related to the language information are created (or configured) in a plurality descriptors, and the remaining parts of the search information are created (or configured) as commonly shared structures. For example, the structure of the search information shown in FIG. 9B includes the number of languages “Num_of_languages” 1013 supported in the general information field “EnhancedSearch_GI( )” field 101, which included in the search file 100. And, only the C-Map_Char_Descriptor 1012b, which indicates the characters of the corresponding Character-Map, the IS-Map_Item_Descriptor 1032a, which is information indicating the characterisitics of a corresponding Item-Map, and the Entry_Descriptor 1042b, which indicates the characters of the corresponding entry, are separately included for each supported language. Thus, a search information for each of the supported languages can be provided within a single search file.

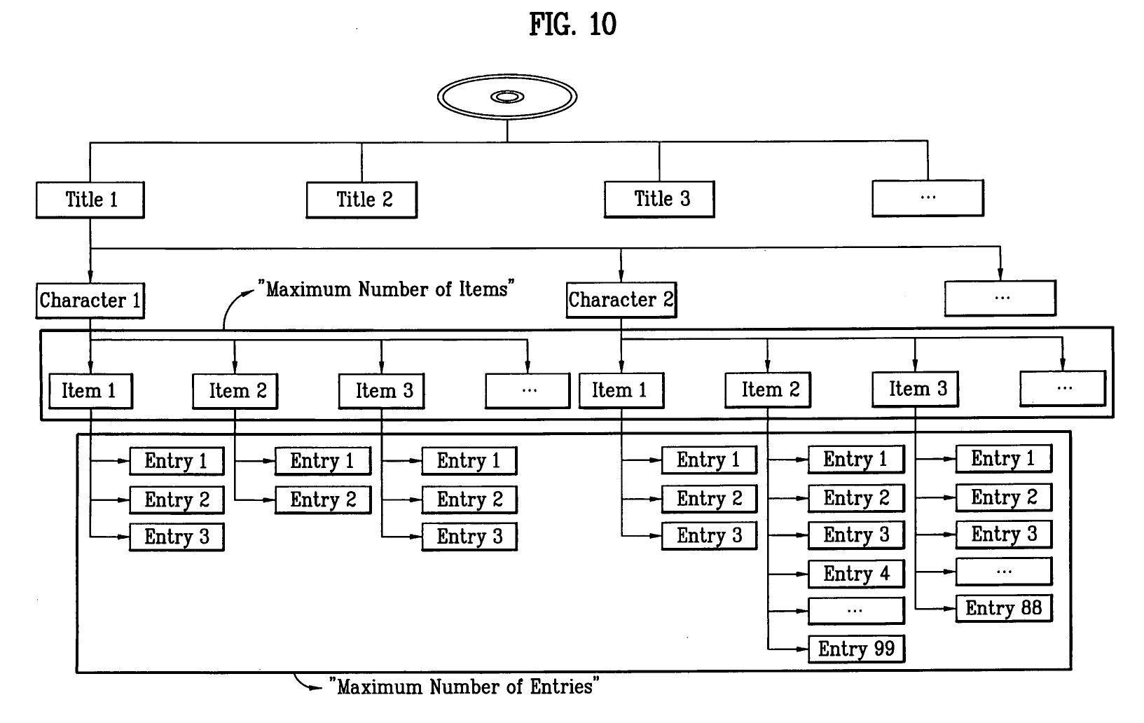

FIG. 10 illustrates a method for managing the search information according to the embodiment of the present invention. Referring to FIG. 10, the method for managing the search information relates to managing a maximum possible number of entries and/or items. For example, the maximum number of entries and/or items existing within the entire optical disc may be limited, the maximum number of entries and/or items existing within a specific Character-Map may be limited, or the maximum number of entries existing within a specific Item-Map may be limited. Furthermore, the maximum number of entries and/or items existing within a specific search file may also be limited. As described above, by limiting the maximum number of entries and/or items configuring the search information, the author of the optical disc can design the disc to efficiently include only the necessary search information. This can allow the user to reduce unnecessary searching time.

FIGS. 11A and 11B illustrate an example of the optical recording and/or reproducing apparatus and a player model according to the present invention. More specifically, FIG. 11A illustrates the overall structure of the optical recording and/or reproducing apparatus 10. And, FIG. 11B illustrates a detailed structure of a reproduction processing means 17 or a player model 17b according to the present invention, which is for reproducing an optical disc having titles of different attributes recorded therein. Referring to FIG. 11A, the optical recording and/or reproducing apparatus 10 according to the present invention will now be described in detail.

The optical recording and/or reproducing apparatus 10 includes a pick-up unit 11 for reproducing the management information including the contents recorded in the stream recording area and the file information recorded in a reproduction management area, a servo 14 controlling the operations of the pick-up unit 11, a signal processor 13 either recovering the reproduction (or playback) signal received from the pick-up unit 11 to a desired signal value, or modulating a signal to be recorded to an optical disc recordable signal and transmitting the modulated signal, a memory 15 recording diverse necessary information required for reproducing the optical disc, and a microcomputer 16 controlling the above operations. The above-described structure may be collectively referred to as a recording/reproducing unit 20. Herein, the recording/reproducing unit 20 may be provided as an individual product.

A controller 12 controls all of the components included in the entire structure. More specifically, the controller 12 receives reproduction (or playback) commands of a specific title and search commands for the contents that are included in a title through an interface with the user. A reproduction processing means 17 performs a final decoding of an output data in accordance with the control of the controller 12 and provides the decoded data to the user. More specifically, the reproduction processing means 17 includes a decoder 17a and a player model 17b. The decoder 17a decodes the AV signal, and the player model 17b interprets the object command or program, which is associated with the reproduction of the specific title, and a user command received through the controller 12. Then, the player model 17b decided a reproduction flow in accordance with the interpreted information and command. However, depending upon the embodiment, the player model 17b may also include the decoder 17a. In this case, the reproduction processing means 17 according to the present invention may function as the player model (shown in FIG. 11B). Moreover, in order to record a signal within the optical disc, an AV encoder 18 converts an input signal to a specific format signal (e.g., an MPEG2 transport stream) according to the control of the controller 12 and provides the converted signal to the signal processor 13.

FIG. 11B illustrates a detailed structure of the player model. Herein, a player model that can reproduce both HDMV titles and Java titles will be given as an example of the player model according to the present invention. Referring to FIG. 11B, the player model includes a module manager 171, a movie module 172, a BDJ module 173, a playback control engine 174, and a presentation engine 175. Herein, the movie module 172 and the BDJ module 173 are formed independently as separate means for managing reproduction processing in order to reproduce HDMV and Java titles. More specifically, the movie module 172 reproduces the HDMV titles, and the BDJ module 173 reproduces the Java titles. Both the movie module 172 and the BDJ module 173 have control functions that can receive and process the above-described objects (M-OBJ or J-OBJ), which are received in the form a command or a program. As a means for receiving and processing the command, a command processor 172a is included in the movie module 172, and an application manager 173a and a Java VM 173b are included in the BDJ module 173. Additionally, the module manager 171 not only transmits the user command to the movie module 172 and the BDJ module 173 but also controls the operation of the movie module 172 and the BDJ module 173.

The playback control engine 174 interprets the contents of a PlayList file, which is recorded within the optical disc, in accordance with the reproduction (or playback) command of the movie module 172 and the BDJ module 173, and performs reproduction accordingly. (Herein, the contents of the PlayList file particularly configure the static scenario.) Furthermore, the presentation engine 175 displays the specific stream onto the screen. Herein, the reproduction of the specific stream is managed by the playback control engine 174. Most particularly, the playback control engine 174 consists of a playback control function 174a and player register 174b, wherein the playback control function 174a actually manages all reproduction, and wherein the player registers 174b store (or register) a reproduction environment or reproduction status (or condition) of the player. Herein, the player registers 174b record (or register) of a plurality of player status registers (PSR) and a plurality of general purpose registers (GPR). In some cases, the playback control function 174a may function and be referred to as the playback control engine 174.

In the player model according to the present invention, the module manager 171, the movie module 172, the BDJ module 173, and the playback control engine 174 may be processed by software. Herein, it is actually more advantageous to process the above elements by software rather than hardware. On the other hand, the presentation engine 175, the decoder 17a, and graphic planes 17c and 17d are generally designed as hardware. Most particularly, the elements that may be processed as software (e.g., reference numerals 171, 172, 173, and 174) may also be configured as part of the above-described controller 12. Therefore, it is apparent that each element of the structure of the present invention should be viewed and understood as part of the structure itself and should not be limited to whether each of the elements is formed as a software or hardware.

The player model (shown in FIG. 11B) has the following characteristics. First of all, as described above, each of the movie module 172 reproducing the HDMV titles and the BDJ module 173 reproducing the Java titles is formed independently. Herein, the two modules (172 and 173) are not operated at the same time. In other words, the Java title cannot be reproduced while the HDMV title is being reproduced. And, the HDMV title cannot be reproduced while the Java title is being reproduced.

In addition, each of the HDMV titles and Java titles receives a user command by a different method, and their methods of executing the received user command are also independent from one another. In this case, however, a means for receiving the user command and transmitting the received command to one of the movie module 172 and the BDJ module 173. In the present invention, a user event manager 171a included in the module manager 171 performs such function. For example, when the received user command is a command made by a user operation (UO), the user event manager 171a transmits the received command to a UO controller 172b included in the movie module 172 so that the user command can be executed. And, when the received user command is a command made by a key event, the user event manager 171a transmits the received command to a Java VM 173b included in the BDJ module 173 so that the user command can be executed.

Furthermore, any one of the modules (172 or 173) that is currently being operated manages (or masters) the playback control engine 174. More specifically, the movie module 172 is mastered while the HDMV title is being reproduced, and the BDJ module 173 is mastered while the Java title is being reproduced. Finally, the graphic plane is also managed independently. For example, the operation of an HDMV plane 17c is mastered by the presentation engine 175, and the operation of a Java plane 17d is mastered by the Java VM 173b included in the BDJ module 173.

A method for reproducing the optical disc by using the optical recording and/or reproducing apparatus according to the present invention will now be described in detail. More specifically, when the optical disc having the above-described reproduction management file structure recorded therein in accordance with any one of the above-described embodiments (shown in FIGS. 2A to 2D) is loaded in the optical recording and/or reproducing apparatus 10, the microcomputer 16 reads the file information recorded within the optical disc by using the pick-up unit 11. Then, the microcomputer 16 stores the read information within the memory 15. Subsequently, after a user-selection command for reproducing a specific title is inputted by using the controller 12, the microcomputer 16 reads a specific set of data in accordance with a reproduction scenario corresponding to the selected title. Then, the microcomputer 16 transmits the read data to the player model (shown in FIG. 11B). Thereafter, in accordance with the reproduction scenario verified by the attribute of the corresponding title and by each object file (which decides the dynamic scenario) and PlayList file (which decides the static scenario), the player model (shown in FIG. 11B) operates one of the movie module 172 and the BDJ module 173, so as to perform a final reproduction of the title selected by the user.

Accordingly, there are two methods of searching specific contents within a corresponding title while reproducing the title. One of the methods consists of pausing the reproduction of the title once the user inputs a search command for a specific set of contents within the corresponding title, which is being reproduced. Then, the specific set of contents included in the title is searched from the search information within the above-described file. Thereafter, the search operation is completed (or ended), and the reproduction of the title is resumed starting from the point (or position) where the reproduction (or playback) has been paused. In other words, after pausing the reproduction of the title and performing the search operation, and after a lapse of a predetermined period of time according to a request of the user or a system command, the reproduction is automatically resumed starting from the paused point (or position) of the title that is being reproduced. The other method consists of stopping the reproduction of the title once the user inputs a search command for a specific set of contents within the corresponding title, which is being reproduced. Then, the specific set of contents included in the title is searched from the search information within the above-described file. Thereafter, according to the result of the search operation, the reproduction of the title is resumed starting from the searched scene that is finally selected. In other words, after completely terminating (or ending) the reproduction of the title and performing the search operation, the reproduction of the title is resumed starting from a scene selected by the user.

As described above, the recording medium, the method for searching contents recorded within the recording medium, and the method and apparatus for reproducing the recorded contents have the following advantages. By using the present invention, a wide range of contents recorded in the recording medium can be easily searched and provided. Moreover, the reproduction of the recording medium can be efficiently managed, thereby providing the user with more convenient functions.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A recording medium comprising an area having a plurality of contents recorded therein, and a management area having a search file for searching the contents recorded therein, wherein the search file includes at least one entry classifying the contents by scenes and including information having an attribute defined for each scene.

2. The recording medium of claim 1, wherein the search file further comprises map information that is classified by the attribute of the entry.

3. The recording medium of claim 2, wherein the map information recorded in the search file consists of a plurality of item maps (IS-Maps) designating an entry having the same item attribute among the at least one entry, and a plurality of character maps (C-Maps) designating an item map (IS-Map) having the same character among the plurality of item maps (IS-Maps).

4. The recording medium of claim 3, wherein the plurality of character maps (C-Maps) includes a character map (C-Map) configured based on characters featuring in the contents, and a character map (C-Map) configured based on places featuring in the contents.

5. The recording medium of claim 1, wherein the search file consists of meta data.

6. The recording medium of claim 5, wherein the meta data within the search file consist of a hierarchical structure.

7. The recording medium of claim 3, wherein the search file configures each of the plurality of character maps (C-Maps), the plurality of item maps (IS-Maps), and the at least one entry, and wherein the search file includes a plurality of descriptors designating a mapping relationship between the character maps (C-Maps), item maps (IS-Maps), and at least one entry.

8. The recording medium of claim 7, wherein each of the at least one entry is mapped to at least one item map (IS-Map).

9. The recording medium of claim 4, wherein each of the item maps (IS-Maps) is mapped to at least one character map (C-Map).

10. The recording medium of claim 1, wherein the search file is configured in separate files for each language.

11. The recording medium of claim 1, wherein the search file is configured in a single file having all supported languages integrated therein.

12. The recording medium of claim 11, wherein the search file includes separate descriptors for each supported language.

13. The recording medium of claim 11, wherein the search file includes a Num_of_language field indicating a number of the supported languages.

14. The recording medium of claim 1, wherein the search file is recorded in an auxiliary data directory (AUXDATA).

15. The recording medium of claim 1, wherein the search file is recorded in a meta data directory (META).

16. The recording medium of claim 1, wherein the management area further comprises a PlayList file managing reproduction of the contents.

17. The recording medium of claim 1, wherein the search file is distinguished by PlayList file units.

18. The recording medium of claim 17, wherein a file name indicating the search file includes a file descriptor indicating that the file is a search file, information on the languages supported by the search file, and information on a specific PlayList file associated with the search file.

19. The recording medium of claim 1, wherein each entry within the search file includes an entry_pointer having location information of an associated scene recorded in the recording medium.

20. The recording medium of claim 2, wherein a number of items that are included in the recording medium is within a predetermined maximum number range.

21. The recording medium of claim 2, wherein a number of entries that are included in the recording medium is within a predetermined maximum number range.

22. The recording medium of claim 21, wherein the number of entries that are included in the recording medium is within the predetermined maximum number range for each search file.

23. A method for searching contents recorded within a recording medium, comprises:
providing character information for each character map (C-Map) recorded within a search file in accordance with a contents search command;
providing item information for each at least one item map (IS-Map) corresponding to a selected character among the provided character information;
providing an entry corresponding to a selected item among the provided item information; and
searching the corresponding entry by using entry location information recorded within the selected entry among the provided entries.

24. In reproducing a recording medium comprising at least one title recording area, and a management area having a management file for reproducing a title and a search file each recorded therein, a method for reproducing the recording medium comprising:
reading an index file and an object file both recorded in the management area within the recording medium;
when a reproduction command for a specific title is inputted by the index file, executing a specific object file associated with the corresponding specific title;
when a search command for a set of contents within the title is inputted while the title is being reproduced by using the object file, pausing the reproduction of the title and searching the specific set of contents within the title from a search information included in the search file; and
after ending the search operation, resuming the reproduction of the title starting from a presentation point at which the reproduction has been paused.

25. In reproducing a recording medium comprising at least one title recording area, and a management area having a management file for reproducing a title and a search file each recorded therein, a method for reproducing the recording medium comprising:
reading an index file and an object file both recorded in the management area within the recording medium;
when a reproduction command for a specific title is inputted by the index file, executing a specific object file associated with the corresponding specific title;
when a search command for a set of contents within the title is inputted while the title is being reproduced by using the object file, stopping the reproduction of the title and searching the specific set of contents within the title from a search information included in the search file; and
in accordance with a result of the search operation, resuming the reproduction of the title starting from a searched scene which is finally selected by a user.

26. In reproducing a recording medium comprising at least one title recording area, and a management area having a management file for reproducing a title and a search file each recorded therein, an apparatus for reproducing the recording medium comprising:
a recording/reproducing unit reading an index file and an object file both recorded in the management area within the recording medium; and
a player model executing a specific object file associated with the corresponding specific title, when a reproduction command for a specific title is inputted by the index file, pausing the reproduction of the title and searching the specific set of contents within the title from a search information included in the search file, when a search command for a set of contents within the title is inputted while the title is being reproduced by using the object file, and resuming the reproduction of the title starting from a presentation point at which the reproduction has been paused after ending the search operation.

27. In reproducing a recording medium comprising at least one title recording area, and a management area having a management file for reproducing a title and a search file each recorded therein, an apparatus for reproducing the recording medium comprising:
a recording/reproducing unit reading an index file and an object file both recorded in the management area within the recording medium; and
a player model executing a specific object file associated with the corresponding specific title, when a reproduction command for a specific title is inputted by the index file, stopping the reproduction of the title and searching the specific set of contents within the title from a search information included in the search file, when a search command for a set of contents within the title is inputted while the title is being reproduced by using the object file, and resuming the reproduction of the title starting from a searched scene which is finally selected by a user in accordance with a result of the search operation.
